(19) United States
(12) Patent Application Publication
(10) Pub. No.: US 2007/0101638 A1
(43) Pub. Date: May 10, 2007

(54) Fishing weight

(76) Inventor: Carl Dragna JR., Las Vegas, NE (US)

Correspondence Address: WEISS & MOY PC, 4204 NORTH BROWN AVENUE, SCOTTSDALE, AZ, 85251, US

(21) Appl. No.: 11/272,231

(22) Filed: Nov. 10, 2005

(51) Int. Cl. A01K 95/00

(52) U.S. Cl. 43/43.14

(57) ABSTRACT

An improved fishing weight is provided that includes non-leaded filler material packed within a rubberized hollow body, and an end cap for sealing the non-leaded filler material within said hollow body. A plug grommet may also be used to include an eyelet to attach the fishing weight to the fishing line. The improved lead-free fishing weight is environmentally friendly and safer for anglers to use. The improved fishing weight permits substantially better casting and resistance to snagging on submerged branches, etc.

### FIELD OF THE INVENTION

This invention relates generally to fishing and more particularly, to a substantially safe and environmentally friendly fishing weight.

### BACKGROUND OF THE INVENTION

Fishing weights are used to help cast, drift, anchor, sink and troll and present all kinds of baits and lures. Fishing weights help keep the bait or lure down in the water and help swing it away from the angler. The shape and design of the fishing weight depend on the type of fishing to be done. The general wisdom about fishing weights is to use as little weight as one possibly can. Otherwise, fish may be discouraged from striking because of the resistance that fishing weights give lines and lures. In addition, too heavy weights may cause the angler to miss strikes from the fish. Fishing weights may also be categorized as sinkers (weights affixed to the fishing line). Sinkers are frequently lost when snagged on rocks, fallen trees, or other submerged hazards. They are also sometimes simply dropped or spilled while handling and not recovered.

Traditional fishing weights have been made from solid lead. When lead fishing weights or sinkers are lost through broken line or these other means, mammals and birds can inadvertently eat them. Water birds like loons and swans often swallow lead when they scoop up pebbles from the bottom of a lake or river to help grind their food. Eagles ingest lead by eating fish which have themselves swallowed sinkers. Unfortunately, lead is a toxic metal that, in sufficient quantities, has adverse effects on the nervous and reproductive systems of mammals and birds. For example, a bird with lead poisoning will suffer loss of balance, gasping, tremors and an impaired ability to fly. The weakened bird is more vulnerable to predators, or it may have trouble feeding, mating, nesting, and caring for its young. The bird often becomes emaciated and often dies within a short time after eating the leaded fishing weight.

An angler is also adversely affected by the handling of leaded fishing weights and his or her tackle box containing such leaded tackle. As a result, the sale and use of certain leaded fishing weights has been banned in various places and replaced by “non-toxic fishing weights” made from non-poisonous materials such as bismuth, iron, copper, steel, tin, tungsten, alloys of these metals, and metal/plastic or metal/ceramic combinations or the like. Unfortunately, even fishing weights made of these materials have been known to injure anglers and those people and animals around him or her and to cause damage to boats and other property when being cast or the like because of their weight and hardness.

Accordingly, there has been a need for a novel fishing weight which is of simplified construction, inexpensive to manufacture, and substantially safe and easy to use. There is an additional need for a novel fishing weight which is substantially nontoxic and environmentally friendly to help safeguard wildlife and human health. There is a further need for a novel fishing weight that is easier to tie to a fishing line and permits farther and accurate casting. There is a still further need for a novel fishing weight that helps release and rebound from snag and other conditions. There is a still additional need for a novel fishing weight that has a long life without substantial rusting. The present invention fulfills these needs and provides other related advantages.

### SUMMARY OF THE INVENTION

In accordance with one embodiment of the present invention, the fishing weight comprises, generally, a resilient hollow body, non-leaded filler material packed to capacity within the resilient hollow body, and means to attach the resilient hollow body to a fishing line.

In accordance with another embodiment of the present invention, the fishing weight comprises, generally, a substantially resilient hollow body having an open bottom for receiving the non-leaded filler material, an end cap mountable in the open bottom of the body for retaining the filler material in the body, and a fastening member for affixing the fishing weight to a fishing line.

In accordance with another embodiment of the present invention, the fishing weight comprises, generally, a substantially resilient hollow body having an open bottom for receiving filler material, an end cap mountable in the open bottom of the body for retaining the filler material in the body, and an aperture in the top of the body adapted to receive a closure member.

The method of constructing the fishing weight is also provided.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of a fishing weight embodying the invention, illustrating a fishing line tied to a fastening member of the fishing weight;

FIG. 2 is a sectional view of the fishing weight of FIG. 1, illustrating a hollow body having a neck in which the fastening member is secured, the interior of the body containing filler material retained therein by an end cap mounted in an open bottom of the body;

FIG. 3 is a perspective assembly view of the fishing weight of FIGS. 1 and 2, illustrating placing filler material through the open bottom of the body before mounting the end cap therein to retain the filler material inside the body;

FIG. 4 is an enlarged sectional view of another embodiment of a fishing weight, illustrating a plug grommet in an aperture defined in the top of the hollow body, the plug grommet including the fastening member; and

FIG. 5 is an assembly view of the insertion of the plug grommet in the aperture of the fishing weight of FIG. 4, illustrating the use of an exemplary T-handle tool to latch onto the fastening member to pull a top portion of the plug grommet from the inside of the hollow body through the aperture defined in the top of the hollow body.

### DETAILED DESCRIPTION OF THE PREFERRED EMBODIMENTS

As shown in the drawings for purposes of illustration, the present invention is concerned with an improved fishing weight, generally designated in the accompanying drawings by the reference number 10. The fishing weight 10 comprises, generally, a substantially resilient hollow body 12 having an open bottom for receiving filler material 14, an end cap 16 mountable in the open bottom of the body for retaining the filler material in the body, and a fastening member 18 for affixing the fishing weight 10 to a fishing line 20. The body 12 may further have an aperture 22 at the top thereof for receiving a plug grommet 24.

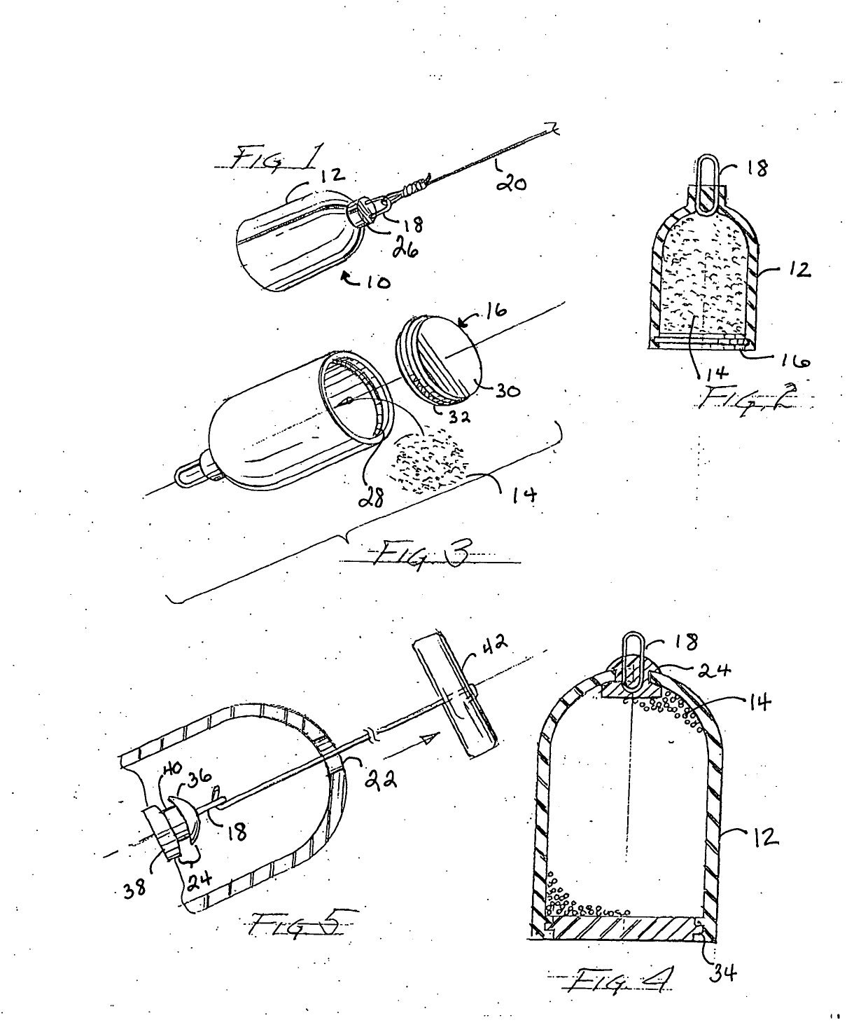

In accordance with the present invention, and as illustrated with respect to a preferred embodiment in FIGS. 1-5, the body 12 may be substantially cylindrical defining a hollow interior and having a dome shaped top portion and the open bottom. In a first embodiment as shown in FIGS. 1-3, the dome-shaped top portion may extend upwardly to define a neck 26 into which the fastening member 18 is secured. The inside surface of the body 12 near the open bottom may include a channel 28 for mounting of the end cap 16 as hereinafter described.

The body 12 may be molded from natural and synthetic rubber (compounds) and elastomers. In a preferred form, the hollow body may be molded from Styrene butadiene rubber (SBR) available from, for example R & S Processing Company, Inc. in Paramount, Calif. or the like. Other suitable natural and synthetic rubber (compounds) and elastomers for molding the body may include ethylene propylene diene (EPDM), polychloroprene (CR), butyl rubber, and polyisoprene (IR), crossblends or the like. It is to be appreciated that other natural and synthetic rubber (compounds) and elastomers may be used within the confines of the invention to produce a molded body that has at least “good” tear resistance, moisture resistance, abrasion resistance, and UV resistance as defined in ASTM standards. The hardness of the hollow body may be between about 55 to about 70 durometers (Shore A), preferably about 65 durometers with the minimum elongation of about 200% and a minimum tensile strength (psi) of about 1200 psi.

The elastomeric or rubber compound may be reinforced with a nylon mesh fabric, fiberglass fabric, or the like (not shown) to improve tear strength of the body. The fabric may be sandwiched in with the elastomeric or rubber compound during the molding process. Suitable nylon mesh fabric is available from 21^{st} Century Textiles, Los Angeles, Calif. Use of the reinforcing nylon mesh fabric may be particularly helpful for the larger size fishing weights (e.g. 10-50 pound weights).

The hollow body may be manufactured by known molding techniques such as injection molding, compression molding, transfer molding, dip molding and the like. Compression molding is the preferred molding technique.

The filler material 14 may include non-toxic steel shot or other non-toxic shot or punching material (e.g. steel punchings). Suitable steel shot is available from Kelco Sales & Engineering Co., Norwalk, Calif. The preferred size ranges from about 0.65 mm to about 1.0 mm, the preferred size being about 0.85 mm and spherically-shaped. The smaller size permits packing the body interior with steel shot substantially to capacity to substantially eliminate air pockets which may cause problems with the functioning of the fishing weight. The smaller size also pours easily and dissipates in the water if separated from the body. FIGS. 2 and 4 illustrate fishing weights substantially filled to capacity with the filler material.

The fishing weight 10 may be available in a variety of sizes and weights, the larger fishing weights used for example in commercial fishing. The table below sets forth the exemplary wall thickness for a variety of the fishing weights.

| Fishing Weight | | | |
|---|---|---|---|
| (total weight) | | | Wall thickness (in.) |
| | 1 | ounce-1 pound | .075 |
| | 1.5 | pounds-3 pounds | .120 |
| | 5 | pounds | .150 |
| | 10 | pounds | .200 |
| | 20 | pounds | .250 |
| | 30 | pounds | .300 |
| | 40 | pounds | .400 |
| | 50 | pounds | .500 |

The end cap or plug 16 comprises substantially thin, flat and circular top and bottom portions 30 and 32 with an annular flange 34 therebetween. The bottom portion 32 of the end cap 16 may have a slightly smaller diameter and thickness than the top portion 30 for close fitting in the open bottom of the body with the bottom portion substantially flush with the bottom of the body as shown in FIGS. 2 and 4. This arrangement enables the fishing weight 10 to stand substantially level and upright on a surface making it easier to tie the fishing line to the weight. The annular flange 34 of the end cap may be received into the channel 28 on the inside surface of the body in a tongue and groove arrangement. The end cap 16 may be molded from the same material as the body. The end cap 16 may be affixed into the open bottom of the hollow body by the use of adhesive or other known water resistant rubber adhesive or sealant. A suitable adhesive named Scotch Grip™ rubber and gasket adhesive (2141 and 1300) is available from 3M Corporation (St Paul, Minn.). The adhesive is brushed onto the end cap to provide a strong bond between the end cap and the body. The thickness of the end cap may be as follows:

| | | |
|---|---|---|
| 1 oz.-1 lb. | .250 | inches |
| 1.5 lbs.-3 lbs | .300 | inches |
| 5 lbs.-50 lbs. | .350-.625 | inches |

It is to be appreciated that the thickness of the end cap may vary within the confines of the invention.

In another embodiment as shown in FIGS. 4 and 5, the body 12 may further define the opening or aperture 22 at the dome-shaped top of the body for receiving the plug grommet 24. The plug grommet may be used in the fishing weight to add strength to the weight. For this reason, the plug grommet may be used more often on the heavier and larger weights (i.e. greater than 1.0 pounds) than on the smaller weights. The diameter of the aperture 22 may increase to accommodate increasingly larger plug grommets. The plug grommet may be of solid, unitary one-piece construction and comprises a plano-convex upper portion 36 and a lower flange portion 38 with a groove 40 therebetween. The flange diameter is larger than the diameter of the aperture 22, preferably about twice the size of the aperture.

To position the plug grommet within the aperture, a T-handle tool 42 or the like may be provided for latching onto the fastening member 18 or eyelet and pulling the upper portion 36 of the plug grommet 24 through the aperture 22 until the groove 40 is secured around the wall of the body. An exemplary suitable tool is available from Bondhus Corporation, Monticello, Minn. 55362 (Balldriver® T-Handle Singles—2 mm with a straight hex tip, part no. 13252). The tip may be curved to define a hook to more easily latch onto the eyelet. When positioned, the plug grommet 24 extends into the body 12 through the aperture 22 with the flange 38 inside the body and abutting against the inside top surface of the body and the flat side of the upper portion 36 of the plug grommet extending outside of the body abutting against the outside top surface of the body. The plug grommet 24 may be comprised of the same material from which the body is molded and the groove thickness sized to closely fit into the aperture and fit around the top wall of the body. The groove width and groove diameter correspond respectively to the thickness of the material into which the plug grommet is inserted (i.e. the thickness of the body walls) and groove diameter is the inside diameter of the groove. The plug grommet 24 may be affixed in the aperture 22 by use of the same adhesive or the like used to affix the end cap.

The fastening member 18 may include a small metal eye or the like that enables the fishing weight to be tied to the fishing line 20. In a preferred form, the eye is substantially oblong-shaped and comprised of a non-toxic metal such as galvanized steel wire which is substantially non-toxic and rust-resistant. The diameter of the wire may increase as the fishing weight gets larger and heavier. For example, a 0.060 diameter wire may be used with smaller weights of one to 12 ounces and a 0.080 diameter wire may be used with 1-3 pound fishing weights. Suitable galvanized steel wire is available at most supply companies and hardware stores. A bottom portion of the fastening member 18 may be molded in place in the neck 26 of the body (FIGS. 1-3) or in the upper portion 36 of the plug grommet (FIGS. 4 and 5) to form a mechanical bond with the body or plug grommet respectively, with a top portion protruding outwardly therefrom to affix the fishing line 20.

The method of constructing the fishing weight 10 is also provided. The method comprises the steps of:

Providing a resilient hollow body with an opening for receiving filler material;

Pouring the filler material through the opening and packing the filler material into the resilient hollow body until substantially full; and

Sealing the opening of the resilient hollow body with a closure member.

Although filling the body with filler material through the open bottom has been described and shown, it is to be appreciated that the body may be filled through the aperture if the bottom of the body is closed by the end cap or if the body is of a unitary construction without an open bottom. In addition, although construction of the fishing weight has been described, it is to be appreciated that the fishing weight may be preconstructed.

From the foregoing, it is to be appreciated that the improved fishing weight of the present invention is substantially safe and easy to use for better casting and release and rebound from snag and other conditions, environmentally friendly, and relatively simple and inexpensive to manufacture and construct.

Although a particular embodiment of the invention has been described in detail for purposes of illustration, various modifications may be made without departing from the spirit and scope of the invention. Accordingly, the invention is not to be limited, except as by the appended claims.

1. A fishing weight comprising:
a molded substantially resilient hollow body;
a substantially fixed amount of non-leaded filler material substantially packed to capacity and retained within the molded substantially resilient hollow body; and
means to attach the molded substantially resilient hollow body to a fishing line.

2. The fishing weight of claim 1, wherein the non-leaded filler material comprises steel shot.

3. The fishing weight of claim 1, wherein the molded substantially resilient hollow body is comprised of natural and synthetic elastomers and rubber compounds selected from the group consisting of styrene butadiene rubber (SBR), ethylene propylene diene (EPDM), polychloroprene (CR), butyl rubber, polyisoprene (IR), and crossblends thereof.

4. The fishing weight of claim 3, wherein the molded substantially resilient hollow body further comprises a nylon mesh fabric for reinforcement thereof.

5. The fishing weight of claim 1, wherein the molded substantially resilient hollow body has an open bottom for mounting of an end cap therein.

6. The fishing weight of claim 1, wherein the means to attach the molded substantially resilient hollow body to a fishing line comprises a fastening member mechanically bonded thereto.

7. The fishing weight of claim 6, wherein the fastening member comprises a galvanized steel eye.

8. A fishing weight, comprising:
a substantially resilient hollow body having at least one opening and adapted for receiving non-leaded filler material;
a closure member for the at least one opening for sealing and retaining a substantially fixed amount of the non-leaded filler material in the substantially resilient hollow body;
non-leaded filler material; and
a fastening member to secure the substantially resilient hollow body to a fishing line.

9. The fishing weight of claim 8, wherein the at least opening comprises an open bottom of the substantially resilient hollow body and the closure member is an end cap.

10. The fishing weight of claim 8, wherein the at least one opening comprises an aperture at the top of the substantially resilient hollow body and the closure member is a plug grommet.

11. The fishing weight of claim 9, wherein the at least opening comprises the open bottom of the resilient hollow body and an aperture at the top of the resilient hollow body.

12. The fishing weight of claim 8, wherein the fastening member is mechanically bonded to a neck of the substantially resilient hollow body.

13. A fishing weight, comprising:
a substantially resilient hollow cylindrical body with a substantially dome-shaped top portion and an open bottom for receiving filler material;
an end cap fixed in the open bottom for sealing the filler material inside the substantially resilient hollow cylindrical body; and
a fastener at the top of the substantially resilient hollow cylindrical body for attaching the fishing weight to a fishing line.

14. The fishing weight of claim 13, further comprising an aperture at the top of the substantially resilient hollow cylindrical body for receiving a plug grommet therein, the plug grommet including the fastener for attaching the fishing weight to the fishing line.

15. The fishing weight of claim 14, wherein the plug grommet comprises an upper portion and a lower flange portion with a groove therebetween, the fastener extending from the upper portion.

16. A method of constructing a fishing weight, comprising the steps of:
Providing a substantially resilient hollow body having an open bottom;
Packing the resilient hollow body with a substantially fixed amount of filler material through the open bottom; and
Mounting an end cap in the open bottom to seal and retain the substantially fixed amount of filler material within the resilient hollow body.

17. The method of claim 16, further comprising the step of mounting a plug grommet in an aperture in the top of the resilient hollow body.

18. The method of claim 17, wherein the plug grommet has an upper portion and a lower flange portion with a groove therebetween.

19. The method of claim 18, wherein the plug grommet includes a fastening member extending from the upper portion adapted to fasten to a fishing line.

20. The method of claim 17, wherein the step of mounting the plug grommet comprises latching onto the fastening member and pulling the upper portion of the plug grommet through the aperture to the outside of the substantially resilient hollow body to position the plug grommet in the aperture.
